(19) United States
(12) Patent Application Publication
(10) Pub. No.: US 2022/0331807 A1
(43) Pub. Date: Oct. 20, 2022

(54) TEST TUBE RACK

(71) Applicant: NGNY DEVICES,S.L., Barcelona, Esplugues De Llobregat (ES)

(72) Inventor: Joan VILADOMAT LOPEZ, Barcelona, Esplugues De Llobregat (ES)

(73) Assignee: NGNY DEVICES,S.L., Barcelona, Esplugues De Llobregat (ES)

(21) Appl. No.: 17/762,641

(22) PCT Filed: Sep. 28, 2020
(86) PCT No.: PCT/ES2020/070581

§ 371 Date: Mar. 22, 2022

(30) Foreign Application Priority Data
Sep. 26, 2019 (ES) U201931554

(51) Int. Cl. B01L 9/06

(52) U.S. Cl. CPC B01L 9/06; B01L 2200/023; B01L 2200/025; B01L 2300/126

(57) ABSTRACT

A test tube rack having at least one perforated surface for the insertion of tubes that are held in a vertical position is disclosed. The rack being formed by at least one first pre-cut cardboard sheet is provided with fold lines that, prior to use, defines a laminar body having a minimal thickness, and, at the time of use, it may be assembled to form a volumetric body having at least one upper platform including perforations and maintaining the vertical position of the tubes inserted into the perforations, in turn, can be adjusted to the diameter of the tube as to receive tubes of different diameters. The test tube rack may have a second lower platform with perforations positioned in vertical alignment with the perforations in the upper platform that the tubes inserted therein are gripped at two heights.

### OBJECT OF THE INVENTION

The invention, as stated in the title of the present specification, relates to a test tube rack which contributes, to its intended use, advantages and features, which are described in detail further on, which imply an improvement in the current state of the art.

The object of the present invention relates, specifically, to a test tube rack having the particularity of being formed by at least one pre-cut and folded cardboard sheet, providing significant advantages compared to currently existing racks, because with a minimal economic cost, it enables use with automatons and analysing apparatus holding all the tubes in a perfectly vertical position, receiving tubes of different diameters and occupying minimal space when not in use.

### FIELD OF APPLICATION OF THE INVENTION

The field of application of the present invention falls within the industrial sector dedicated to the manufacture of medical apparatus, devices and utensils, particularly focusing on the area of laboratory utensils.

### BACKGROUND OF THE INVENTION

Transporting tubes of biological samples or test tubes, both from the extraction centre to the laboratory and internally across departments of laboratories, is known to be carried out using racks which never meet all the desired requirements, that is:
being automatable by robots, since to do this it is necessary for the tubes placed therein to be centred with respect to the housings and in a perfectly vertical position;
receiving different tube diameters;
not occupying space when not in use, because at present they occupy a lot of space both when they are full and when they are empty waiting to receive tubes;
not having to be cleaned and disinfected to use them for different purposes;

Moreover, it would be desirable for the price not to be a problem in order to meet said requirements, since the most cost-effective racks on the market today do have a problem and that is that they either cannot receive tubes of different diameters or else they have openings of different diameters but the tubes do not always stay in the vertical position, making it impossible to use the rack with automatons and automated analysers, and in contrast, although the most expensive racks may overcome both problems, in addition to the increase in economic cost, they present two other problems: they occupy more space, enabling a lower density of tubes per surface, and they are harder to clean and disinfect, as they have hard-to-access corners in the mechanisms or springs they have.

Therefore, there are many types of racks for housing tubes, racks made of different materials, having different prices and different volumes, in laboratories today.

These racks occupy a very large space, even when they are not being used, making it necessary to have a space available for storing same.

Racks suitable for analysers and robots have a high price and low density of tubes.

The simplest racks, consisting of simple trays made of metal, plastic or expanded polystyrene, do not have an element that correctly positions the tubes so that they may be processed by automatons and analysers. This entails a further biological risk, since laboratory operators must manually handle the tubes and move them from the rack in order to place them in analysers.

In addition, once the task of the analysers has ended, the tubes must be kept in refrigerators and freezers. In this case, the space (density of tubes per rack) is even more important, and analyser racks are not optimal in this regard. Therefore, operators often have to move the tubes from the rack again. In summary, this entails further risk or having larger refrigerated spaces.

Lastly, once the tubes can be disposed of, the racks must be cleaned and disinfected to prevent possible infections.

The objective of the present invention is, therefore, to provide a new type of racks which enables all the indicated drawbacks to be overcome and all the indicated requirements to be met.

Furthermore, and as a reference to the current state of the art, it should be mentioned that at least the applicant is unaware of the existence of any other test tube rack which presents technical, structural and constitutive features that are the same or similar to those presented by that which is claimed herein.

### DESCRIPTION OF THE INVENTION

The test tube rack proposed by the invention is configured as an ideal solution to the aforementioned objective, the characterising details that make it possible and that distinguish it being conveniently included in the final claims that accompany this description.

More specifically, as indicated above, what the invention proposes is a test tube rack, particular of the type used for placing and transporting tubes with biological samples in extraction centres and laboratories, having the particularity of being formed by at least one pre-cut cardboard sheet with fold lines, such that the operator, at the time of use, can assemble the rack, as if it were a conventional cardboard box, providing important advantages compared to currently existing racks.

More specifically, said cardboard sheet is die cut and provided with the fold lines needed so that, once assembled, it has at least one upper perforated platform and means for holding and maintaining the vertical position of the tubes inserted into the perforations of said platform, said perforations in turn being suitable for receiving tubes of different diameter, since they are configured such that they can be adjusted to the diameter of the tube.

Thus, in one embodiment, the means for holding and maintaining the vertical position of the tubes consist of a second lower platform including perforations positioned in alignment with those of the upper platform such that they grip the tubes at two heights. And in another embodiment, the means for holding and maintaining the vertical position of the tubes consist of circular protrusions or recesses made, for example pressure engraved, on the inner face of the lower base of the box constituting the rack, and arranged in position in alignment with the perforations of the upper platform.

Moreover, in the preferred embodiment, the rack is formed by a first cardboard sheet or main sheet, the assembly of which defines an outer box with the upper perforated platform, and a second cardboard sheet or inner sheet, the assembly of which defines the lower perforated platform. And in the other embodiment, the rack is formed by a single cardboard sheet, the assembly of which defines a box with the upper perforated platform.

Furthermore, in either case, to facilitate the assembly of the rack, said box is preferably sold with a pre-assembly in which the sheet or sheets constituting same are already folded, forming a tubular body having a quadrangular section or a tubular body with a shelf fixed therein, and for the storage and transportation thereof, it is in a flat position, such that it occupies very little space, and for use, simply raising the side walls is sufficient for giving it volume and closing the flaps of the ends.

In turn, in one embodiment, the perforations of the platform or platforms in which the tubes are inserted, and which, as indicated, can be adjusted to the diameter of tubes of different diameters, are circular perforations having a series of radial cuts in their perimetral area such that, when pressing with the tube, they fold, being adjusted to the diameter thereof.

And in another embodiment, said perforations are formed simply by a plurality of star-shaped radial cuts which, when pressing with the tube itself, open up so as to be adjusted to the measurement of the diameter of the tubes. In addition, this option enables the inclusion on the surface of the sheet of marks, for example coloured dots, for being detected by an optical sensor of a PLC-controlled robot automatically placing the tubes.

Therefore, there are multiple main advantages provided by the rack of the invention, such as the following:
The space occupied by the cardboard sheet while it is not in use is minimal.
The arrangement of radial cuts in the perforations for inserting the tubes enables tubes of different diameters to be included in any of them.
The secondary cardboard sheet defining the inner lower platform or the protrusions of the base are means assuring the vertical position of the tubes, since they are always gripped at two points positioned at different heights, and it furthermore keeps them centred at all times.
The rack that is assembled and full of test tubes can be introduced in automatons and analysers similarly to how tubes are loaded by means of the racks themselves in equipment of this type.
The rack can be filled at the extraction centre and be sufficient rigid so as to be transported by the usual means as how biological samples are transported.
The rack can be filled by pre- and post-analytical automatons such that it can be taken to the refrigerator.
The rack can be thrown out together with the tubes once the service life thereof has ended.

### DESCRIPTION OF THE DRAWINGS

To complete the description provided herein, and for the purpose of helping to make the features of the invention more readily understandable, this description is accompanied by a drawing constituting an integral part of the same, which by way of illustration and not limitation represents the following:

FIG. 1 shows a perspective view of a first exemplary embodiment of the test tube rack object of the invention, specifically an example with two perforated platforms and circular perforations with perimetral cuts, represented in the assembled and use position with several tubes included therein, where the main parts and elements it comprises, as well as the configuration and arrangement thereof can be seen.

FIG. 2 shows a perspective view of detail A indicated in FIG. 1, which enables one of the adjustable circular perforations for holding tubes of different diameters, which the rack has according to the invention, to be seen in an enlarged view.

FIG. 3 shows an exploded perspective view of the two sheets of cardboard forming the test tube rack of the invention, according to the example shown in FIG. 1, in this case represented in an unfolded position, where the parts and the configuration thereof can be seen.

FIG. 4 shows a perspective view of a second exemplary embodiment of the test tube rack according to the invention, in this case an example in which the box is pre-assembled, forming a tubular body, in which it only comprises a perforated platform including perforations based on star-shaped cuts and in which, as means for achieving the vertical position of the tubes, comprises circular protrusions at the base of the box.

FIG. 5 shows an enlarged plan view of a portion of the perforated platform of the example of the rack of the invention shown in FIG. 4, where the configuration of the perforations with star-shaped cuts it comprises and the marks for detection by the robot can be seen.

FIG. 6 shows a perspective view of another exemplary embodiment of the test tube rack of the invention, in this case an example in which the box is pre-assembled, forming a tubular body, and internally includes an also pre-assembled second perforated inner platform.

### PREFERRED EMBODIMENT OF THE INVENTION

In view of the aforementioned figures, and in accordance with the adopted numbering, one may observe therein a non-limiting exemplary embodiment of the proposed test tube rack of the invention, comprising what is described in detail below.

Thus, as observed in said figures, the rack (1) in question is formed by at least one first pre-cut cardboard sheet (2) provided with fold lines (3), such that, prior to use, it defines a laminar body having a minimal thickness, and, at the time of use, it may be assembled to form a volumetric body comprising at least one perforated upper platform (4) including perforations (6) and means for maintaining the vertical position (5, 5′) of the tubes (7) inserted into said perforations (6) which, in turn, can be adjusted to the diameter of the tube (7) so as to receive tubes (7) of different diameters.

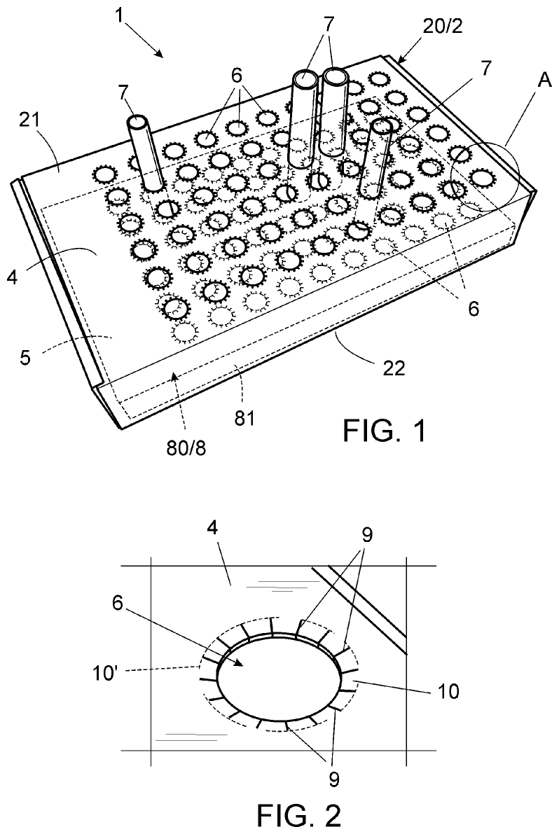

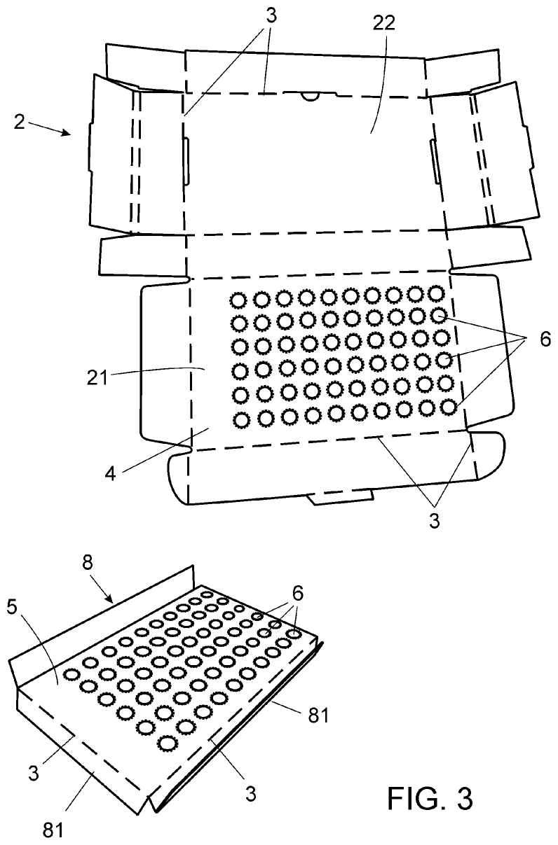

Considering FIGS. 1 and 3, it can be observed how, in one embodiment option, the means for maintaining the vertical position of the tubes (7) are formed by a second perforated lower platform (5) including perforations (6) positioned in vertical alignment with the perforations in the upper platform (4). For that purpose, the rack (1) comprises two platforms, an upper platform (4) and another lower platform (5), both perforated, with a plurality of perforations (6) positioned in vertical in alignment such that the tubes (7) inserted therein are gripped at two heights, keeping them centred therein and in perfect vertical position.

In the preferred embodiment of said option, the rack (1) is formed by two separate sheets of cardboard, where a first cardboard sheet (2) defines, once assembled, a volumetric body in the form of parallelepiped-shaped outer box (20), the upper face (21) of which determines the upper perforated platform (4), and a second, likewise pre-cut cardboard sheet (8) provided with fold lines (3) which, once assembled and located inside the mentioned outer box (20), constitutes an inner shelf (80) defining the lower perforated platform (5) being provided with support walls (81) positioning it at a certain height above the lower base (22) of the outer box (20).

In FIG. 3, the unfolded representation of the first and second cardboard sheets (2, 8) from which the rack (1) of the invention in this embodiment option is formed can be observed, where the different areas defining the pre-cut profile and fold lines (3) thereof for forming, respectively, the outer box (20) and the inner shelf (80) shown in FIG. 1, can be seen.

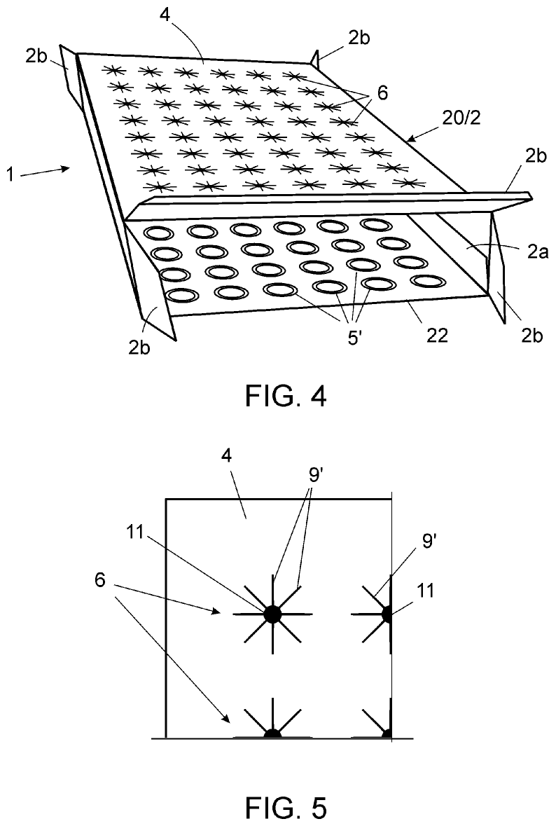

In turn, in another embodiment option shown in FIG. 4, the means for maintaining the vertical position of the tubes (7) are defined by circular protrusions (5′) or projections provided on the inner face of the lower base (22) of the box (20) formed by the cardboard sheet (2), once assembled, in alignment with the perforations (6) of the upper platform (4).

Furthermore, in either embodiment, the box (20) optionally presents a pre-assembly in which the cardboard sheet (2) constituting same, as shown in FIG. 4, is connected to itself by means of a connecting tab (2a), forming a tubular body having a quadrangular section suitable for being arranged in a flat position or for giving it volume and closing the flaps (2b) of the ends.

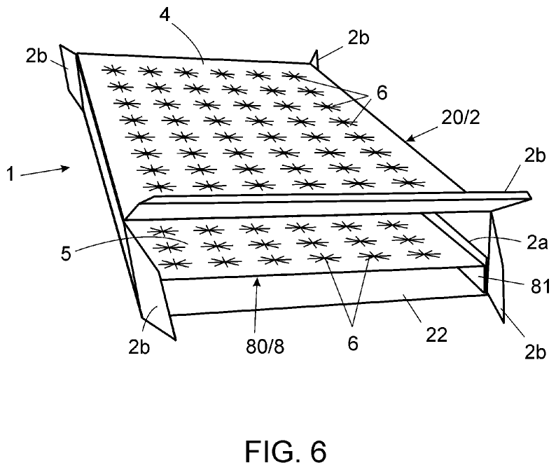

Therefore, as shown in the example of FIG. 6, when the box (20) comprises an inner shelf (80), the second cardboard sheet (8) constituting said shelf is also optionally connected by means of its support walls (81) to the tubular body forming the box (20), which enables it to be taken to a completely flat standby position, for storage and transport, to a use position forming a tubular body with volume in which the flaps (2b) of the ends can be closed.

In any case, the perforations (6), as mentioned, can preferably be adjusted to different diameters of tube (7), for which purpose in one embodiment option, like the one shown in FIGS. 1, 2 and 3, they are circular perforations (6) provided, as can be observed in the detail of FIG. 2, with a plurality of radial cuts (9) defining a perimetral area (10) around each perforation (6) where the material is folded when pressing the tube (7) therein during insertion, being adjusted to same, regardless of the diameter it may have, logically between a minimum and a maximum determined by the length of said radial cuts (9).

In addition, to facilitate said folding of the material in the perimetral area (10) defined by the radial cuts (9) of the circular perforations (6), there is provided a pressing line (10′) on the outer perimeter of said perimetral area (10).

And in another embodiment such as the one shown in FIGS. 4 and 5, the perforations (6) that can be adjusted to the diameter of the tubes (7) are formed by star-shaped radial cuts (9′) such that, when pressing with the tube (7) itself, said cuts open up so as to be adjusted to the measurement of the diameter thereof.

Optionally, as shown in the detail of FIG. 5, the perforations (6) formed by said star-shaped radial cuts (9′) include a mark (11) in the centre, for example a red coloured mark or one of another colour that contrasts with the colour of the sheet (2), susceptible to being detected by an optical sensor of a robot.

Having sufficiently described the nature of the present invention, as well as the ways of implementing it, it is not considered necessary to expand its explanation for any person skilled in the state of the art to understand its scope and the advantages which derive from it.

1. A test tube rack comprising at least one perforated surface (4) for the insertion of tubes (7) that are held in a vertical position, characterised by being formed by at least one first pre-cut cardboard sheet (2) provided with fold lines (3), such that, prior to use, it defines a laminar body having a minimal thickness, and, at the time of use, it may be assembled to form a volumetric body comprising at least one upper platform (4) including perforations (6) and means for maintaining the vertical position (5, 5′) of the tubes (7) inserted into said perforations (6) which, in turn, can be adjusted to the diameter of the tube (7) so as to receive tubes (7) of different diameters.

2. The test tube rack according to claim 1, characterised in that the means for maintaining the vertical position of the tubes (7) are formed by a second perforated lower platform (5) including perforations (6) positioned in vertical alignment with the perforations in the upper platform (4) such that the tubes (7) inserted therein are gripped at two heights.

3. The test tube rack according to claim 2, characterised in that it is formed by two separate sheets of cardboard, where a first cardboard sheet (2) defines, once assembled, a volumetric body in the form of parallelepiped-shaped outer box (20), the upper face (21) of which determines the upper perforated platform (4), and a second, likewise pre-cut cardboard sheet (8) provided with fold lines (3) which, once assembled and located inside the mentioned outer box (20), constitutes a lower shelf (80) defining the lower perforated platform (5) being provided with support walls (81) positioning it at a certain height above the lower base (22) of the outer box (20).

4. The test tube rack according to claim 1, characterised in that the means for maintaining the vertical position of the tubes (7) are formed by circular protrusions (5′) or projections provided on the inner face of the lower base (22) of the box (20) formed by the cardboard sheet (2), once assembled, in alignment with the perforations (6) of the upper platform (4).

5. The test tube rack according to claim 3, characterised in that the box (20) presents a pre-assembly in which the cardboard sheet (2) constituting same is connected to itself by means of a connecting tab (2a), forming a tubular body having a quadrangular section suitable for being arranged in a flat position or for giving it volume and closing the flaps (2b) of the ends.

6. The test tube rack according to claim 5, characterised in that the box (20) has a pre-assembly in which it comprises an inner shelf (80) where the second cardboard sheet (8) constituting said shelf is connected by means of its support walls (81) to the tubular body forming the box (20).

7. The test tube rack according to claim 1, characterised in that the perforations (6) are circular perforations (6) provided with a plurality of radial cuts (9) defining a perimetral area (10) around each perforation (6) where the material is folded when pressing the tube (7) therein during insertion.

8. The test tube rack according to claim 7, characterised in that on the outer perimeter of said perimetral area (10) defined by the radial cuts (9) of the circular perforations (6), there is provided a pressing line (10′).

9. The test tube rack according to claim 1, characterised in that the perforations (6) are formed by star-shaped radial cuts (9′) such that, when pressing with the tube (7) itself, said cuts open up so as to be adjusted to the measurement of the diameter thereof.

10. The test tube rack according to claim 9, characterised in that the perforations (6) formed by star-shaped radial cuts (9′) include a mark (11) in the centre susceptible to being detected by an optical sensor of a robot.
